(19) United States
(12) Patent Application Publication
(10) Pub. No.: US 2026/0369537 A1
(43) Pub. Date: Nov. 19, 2026

(54) AVERAGING AND ION ACCUMULATION

(71) Applicant: Thermo Fisher Scientific (Bremen) GmbH, Bremen (DE)

(72) Inventor: Hamish Stewart, Bremen (DE)

(21) Appl. No.: 19/668,601

(22) Filed: May 5, 2026

(30) Foreign Application Priority Data
May 16, 2025 (GB) 2507598.7
Apr. 17, 2026 (GB) 2608978.9

(51) Int. Cl. H01J 49/00; H01J 49/02; H01J 49/28

(52) U.S. Cl. CPC H01J 49/0031; H01J 49/004; H01J 49/022; H01J 49/28

(57) ABSTRACT

There is provided a method of operating an analytical instrument for analysing ions, the method comprising selecting an ion species for analysis, the selected ion species having a mass; determining a target number of ions based on the mass of the selected ion species; and performing a plurality of mass analysis scans to analyse the selected ion species, wherein the target number of ions is distributed amongst the plurality of mass analysis scans. There is also provided an analytical instrument for performing the method.

### CROSS REFERENCE TO RELATED APPLICATIONS

This application claims benefit of priority to United Kingdom Application No. GB2507598.7, filed May 16, 2025, and United Kingdom Application No. GB2608978.9, filed Apr. 17, 2026, the entire contents of the above applications being incorporated herein by reference.

### FIELD OF INVENTION

The present disclosure relates to the field of mass spectrometry, particularly methods of mass spectrometry in which ions are accumulated in an ion trap.

### BACKGROUND

Direct mass analysis of intact proteins and their collision-induced dissociation products is known as top-down analysis, and preserves substantial information lost in the more common digested peptide measurements, or bottom-up analysis. However, measurement of these large and multiply charged analyte ions is generally a challenge to mass analysers, due to enormous spectral complexity, high charge loads, elevated collisional scatter, interference effects and broad isotopic distributions.

Orbitrap^{TM} analysers are typically limited to ~4 Hz operation in top-down MS/MS due to the analysis time required to achieve sufficient resolution. It is known for the instrument system pressure to be reduced for high mass analytes which helps limit collision probability within the analyser and thus maximises ion lifetime for prolonged, high-resolution measurements. In such known methods this reduced system pressure is a fixed parameter. Very high mass analytes often follow a different method whereby pressure is set high to allow ion capture, then a short length, low-resolution Orbitrap analyser scan made instead.

Orbitrap analysers utilize a paired ion trap to accumulate a predetermined number of ions, up to the maximum capacity of the trap, which are then pulse injected for analysis. Control of this accumulation time is known as automatic gain control or AGC. Time-of-flight analysers typically operate >100x more rapidly, but lack the capability for control of ion numbers in the individual injections, and instead may average over a variable number of scans to accumulate sufficient measured analyte ions.

The Orbitrap^{TM} Astral^{TM} mass spectrometer combines Orbitrap and Astral analysers, and has been considered as a very suitable platform for Top-Down analysis, owing to the Astral analyser’s ability to generate sensitive, high (around 100K) resolution scans over 50 times more rapidly than the Orbitrap analyser alone. However, the Astral analyser has several disadvantages, mainly relating to a more limited ion trapping capacity, dynamic range limitations on single feature intensity due to resonant space charge tolerance and detector saturation, and collisional scattering of high mass ions creating many false positive peaks that interfere with meaningful signal. As well as needing to generate enough signal to overcome this (among other) chemical noise influences, enough ions must also be measured to populate the isotopic envelope, all while charge states are high and in peak space per shot charge limits low (around 1000 charges per isotopic envelope).

Therefore, there remains a need for an improved method of analysing ions.

### SUMMARY

In summary, there is provided a method of operating an analytical instrument for analysing ions, the method comprising: selecting an ion species for analysis, the selected ion species having a mass; determining a target number of ions to be analysed based on the mass of the selected ion species, wherein the target number of ions to be analysed increases with increasing mass of the selected ion species; and performing a plurality of mass analysis scans to analyse the target number of ions, wherein the target number of ions is distributed amongst the plurality of mass analysis scans. The target number of ions are analysed across the plurality of mass analysis scans. In other words, the target number of ions to be analysed are amongst the total number of ions analysed by the plurality of mass analysis scans.

Advantageously, such a method provides an adjustment of the number of ions analysed based on the mass of the ion analyte. This has the advantage that efficiency is increased by spending time accumulating large numbers of top-down measurements only for the higher mass precursors that need them. That way, less beam time is wasted.

The target number of ions for analysis may be a target number of ions to be detected for analysis. The target number of ions to be detected for analysis may be dependent on, or determined based on, the mass of the selected ion species. A selected ion species with a comparatively higher mass would require a target number of ions to be analysed (or to be detected for analysis) that is higher than a selected ion species with a comparatively lower mass. As such, the total number of ions to be detected and analysed across the plurality of mass analysis scans is adjusted based on the selected ion species mass.

The described method is not merely a requirement that a different number of mass analysis scans (or a different total time for analysis) should be employed to provide a same number of a sample molecules to a mass analyser as a result of different sample molecules having different mass (for instance, to account for differing ionisation efficiency, differing ion transmission rate or differing detector sensitivity of ions of different mass). Instead, embodiments require that the target number of ions to be detected is different for ions of different mass. The detection sensitivity of a mass analyser used in the described method may be considered roughly the same for all ion species (in certain examples, consistent with greater than 90% single ion detection). Therefore, the present disclosure modifies how much signal, or how many ions, should be measured or analysed to provide a sufficiency clear analysis result. Overall, the inventors of the present disclosure have recognised that, as the mass of a selected ion species increases and a resulting mass spectrum becomes more complex, then more ions must be measured or analysed in order to provide clear spectral peaks.

Optionally, the target number of ions to be analysed may increase in a continuous or stepped manner.

In an example, determining a target number of ions to be analysed based on the mass of the selected ion species, wherein the target number of ions increases with increasing mass of the selected ion species may comprise determining a target number of ions to be analysed of the selected ion species, the target ion number of ions based on the mass of the selected ion species, wherein the target number of ions increases with increasing mass of the selected ion species. In other words, the method may determine how many, or an amount of, ions of the selected ion species required to be analysed, with the number or amount based on the mass of the selected ion species. As such, the target number of ions may be the target number of ions of the selected ion species. Advantageously, this means that the method ensures the number of ions of the selected ion species analysed is sufficient to provide a high-quality spectrum including well defined peaks for the selected ion species.

Optionally, performing a plurality of mass analysis scans to analyse the selected ion species, wherein the target number of ions is distributed amongst the plurality of mass analysis scans may comprise performing a plurality of mass analysis scans to analyse approximately the target number of ions of the selected ion species (or to analyse at least the target number of ions of the selected ion species), wherein the target number of ions is distributed amongst the plurality of mass analysis scans. In other words, a sufficient number of mass analysis scans may be performed in order to analyse the target number of ions of the selected ion species, or as close as possible to the target number of ions.

In an example, the method may further comprise: determining a number of mass analysis scans required to analyse the target number of ions; and wherein the plurality of mass analysis scans comprises the determined number of mass analysis scans. A number of ions analysed per mass analysis scan may be assumed to be substantially constant across the plurality of mass analysis scans (e.g. substantially constant means the number of ions analysed per scan is ±5% across the plurality of mass analysis scans). Therefore, the number of mass analysis scans required to analyse the target number of ions may be proportional to the target number of ions to be analysed, and so it follows that the number of mass analysis scans required to analyse the target number of ions may increase with increasing mass of the selected ion species.

Optionally, the number of mass analysis scans performed to analyse the selected ion species may be based on the mass of the selected ion species. Put another way, the number of mass analysis scans performed to analyse the selected ion species may be proportional to the mass of the selected ion species.

Optionally, determining a target number of ions to be analysed based on the mass of the selected ion species may comprise determining a number of mass analysis scans required to analyse the target number of ions, wherein the target number of ions to be analysed is based on the mass of the selected ion species. In other words, the number of scans required to analyse the target number of ions may be directly related to the mass of the selected ion species, because the selected ion species mass determines the target number of ions that should be analysed.

Optionally, a detection sensitivity of each mass analysis scan is substantially invariant to the mass of the selected ion species to be analysed. Optionally, the detected proportion of ions per mass analysis scan may be constant and independent of the mass of the selected ion species. As such, increasing the number of mass analysis scans performed within the plurality of mass analysis scans may increase the number of selected ion species that would be detected and analysed.

Optionally, each of the plurality of mass analysis scans may have a predetermined maximum accumulation time such that the number of mass analysis scans performed, or required to be performed, to analyse the selected ion species (and to analyse the target number of ions) is based on the mass of the selected ion species. It will be understood that the total number of ions injected into the mass analyser per scan may be adjusted by adjusting the accumulation time. Therefore, control of a combination of the accumulation time per scan and the total number of scans permits control of the number of ions to be analysed. In this way, the accumulation time and number of scans may be determined in order to ensure that the target number of ions are analysed.

Optionally, each mass analysis scan may produce a result (i.e. mass spectral data, such as a mass spectrum) and the method may comprise taking an average, sum, or weighted sum of the results (i.e. of the mass spectral data, such as of the mass spectra) produced by the plurality of mass analysis scans

Optionally the method may comprise limiting the number of scans in the plurality of scans based on a predetermined maximum number. It may be the case that some precursor ions would require a target number of ions to be analysed, i.e. a number of scans, which would be too great to efficiently operate the analytical instrument. Therefore, a maximum number of scans may be predetermined to avoid such a scenario.

Optionally each of the plurality of mass analysis scans may comprise: accumulating ions in an ion storage device, and injecting the accumulated ions as a pulse into a mass analyser for mass analysis.

Optionally, each of the plurality of mass analysis scans may have an individual target accumulation time.

Optionally the instrument may comprise a time-of-flight mass analyser, wherein analysis of the selected ions species is performed using the time-of-flight mass analyser.

Optionally each mass analysis scan may be an MS2 mass analysis scan.

Optionally each MS2 mass analysis scan may comprise: isolating the selected ion species; fragmenting the isolated ions to produce fragment ions; and mass analysing the fragment ions.

Optionally, before the step of selecting an ion species for analysis, an MS1 scan may be performed to determine the mass of the ion species that is to be selected for analysis.

Optionally the method may further comprise determining a plurality of ion species for analysis from the MS1 scan, wherein the ion species for analysis is selected from the plurality of ion species for analysis.

Optionally the selected ion species is a first ion species having a first mass, wherein the target number of ions is a first target number of ions to be analysed, wherein the plurality of mass analysis scans is a first plurality of mass analysis scans, and wherein the method may further comprise:
selecting a second ion species for analysis, the second ion species having a second mass which is different from the first mass;
determining a second target number of ions to be analysed based on the second mass, wherein the second target number of ions may be different from the first target number of ions; and
performing a second plurality of mass analysis scans to analyse the second ion species, wherein the second target number of ions is distributed amongst the second plurality of mass analysis scans.

Optionally, the number of mass analysis scans comprised within the second plurality of mass analysis scans performed to analyse the second ion species may be different from a number of mass analysis scans comprised within the first plurality of mass analysis scans performed to analyse the first ion species.

Optionally, the ions may be protein ions.

There is also provided an analytical instrument for analysing ions, wherein the analytical instrument is configured to perform any of the methods described herein. In particular, the analytical instrument for analysing ions comprises:
a mass analyser; and
a controller;
wherein the controller is configured to:
   determine a target number of ions to be analysed, the target number of ions based on a mass of the selected ion species, wherein the target number of ions to be analysed increases with increasing selected ion species mass; and
   initiate the performance of a plurality of mass analysis scans by the mass analyser to analyse the selected ion species, wherein the target number of ions is distributed amongst the plurality of mass analysis scans.

The controller is configured to cause the target number of ions to be analysed across the plurality of mass analysis scans. In other words, the target number of ions to be analysed are amongst the total number of ions analysed during the plurality of mass analysis scans. The controller may ensure a suitable number of mass analysis scans are carried out in order to permit analysis of the target number of ions to be analysed. In some examples, the target number of ions may be the target number of ions of the selected ion species.

Optionally, the controller configured to determine a target number of ions to be analysed based on the mass of the selected ion species may comprises the controller configured to: determine a number of mass analysis scans required to analyse the target number of ions, wherein the target number of ions to be analysed is based on the mass of the selected ion species.

Optionally, an expected number of ions analysed per mass analysis scan is invariant or substantially invariant to the mass of the selected ion species to be analysed. In other words, the expected number of ions analysed per scan may assumed not to be dependent on the mass of the selected ion species to be analysed. The detection sensitivity of the mass analyser is substantially constant (e.g. to within 5%) for all detected ion mass. In some cases, the mass analyser has a greater than 90% detection sensitivity for an ion of any mass. This may apply, in particular, for the class of measurements described within the present disclosure, which typically do not consider precursor ions of relatively lower mass. In particular this assumption may be appropriate where the ions for analysis are biomolecule ions or protein ions.

Optionally the instrument may comprise a first mass analyser for analysing a selected ion species.

Optionally, the first mass analyser may be a time-of-flight mass analyser. Additionally or alternatively, the instrument may comprise a second mass analyser which may be an electrostatic orbital trapping analyser.

Optionally the instrument may comprise a second mass analyser used to perform the MS1 scan, wherein the second mass analyser is different to the time-of-flight mass analyser.

The following numbered clauses show further illustrative examples:
1. A method of operating an analytical instrument for analysing ions, the method comprising,
   selecting an ion species for analysis, the selected ion species having a mass;
   determining a target number of ions based on the mass of the selected ion species; and
   performing a plurality of mass analysis scans to analyse the selected ion species, wherein the target number of ions is distributed amongst the plurality of mass analysis scans.
2. The method of clause 1 wherein the target number of ions increases with increasing selected ion species mass.
3. The method of clause 2 wherein the target number of ions increases in a continuous or stepped manner.
4. The method of any preceding clause wherein the number of mass analysis scans performed to analyse the selected ion species is based on the mass of the selected ion species.
5. The method of clause 4 wherein each of the plurality of mass analysis scans has a predetermined maximum accumulation time such that the number of mass analysis scans performed to analyse the selected ion species is based on the mass of the selected ion species.
6. The method of any preceding clause wherein each mass analysis scan produces a result and wherein the method comprises taking an average, sum, or weighted sum of the results produced by the plurality of mass analysis scans
7. The method of any preceding clause further comprising limiting the number of scans in the plurality of scans based on a predetermined maximum number.
8. The method of any preceding clause wherein each of the plurality of mass analysis scans comprises: accumulating ions in an ion storage device, and injecting the accumulated ions as a pulse into a mass analyser for mass analysis.
9. The method of any preceding clause wherein each of the plurality of mass analysis scans has an individual target accumulation time.
10. The method of any preceding clause wherein the instrument comprises a time-of-flight mass analyser, wherein analysis of the selected ions species is performed using the time-of-flight mass analyser.
11. The method of any preceding clause wherein each mass analysis scan is an MS2 mass analysis scan.
12. The method of clause 11 wherein each MS2 mass analysis scan comprises: isolating the selected ion species; fragmenting the isolated ions to produce fragment ions; and mass analysing the fragment ions.
13. The method of any preceding clause further comprising, before the step of selecting an ion species for analysis, performing an MS1 scan to determine the mass of the ion species that is to be selected for analysis.
14. The method of clause 13 further comprising determining a plurality of ion species for analysis from the MS1 scan, wherein the ion species for analysis is selected from the plurality of ion species for analysis.
15. The method of any preceding clause wherein the selected ion species is a first ion species having a first mass, wherein the target number of ions is a first target number of ions, wherein the plurality of mass analysis scans is a first plurality of mass analysis scans, and wherein the method further comprises:
   selecting a second ion species for analysis, the second ion species having a second mass which is different from the first mass;
   determining a second target number of ions based on the second mass, wherein the second target number of ions is different from the first target number of ions; and
   performing a second plurality of mass analysis scans to analyse the second ion species, wherein the second target number of ions is distributed amongst the second plurality of mass analysis scans.
16. The method of clause 15 wherein the number of mass analysis scans performed to analyse the second ion species is different from the number of mass analysis scans performed to analyse the first ion species.
17. The method of any preceding clause wherein the ions are protein ions.
18. An analytic instrument for analysing ions, wherein the analytical instrument is configured to perform the method of any of clauses 1 to 17.
19. The analytical instrument of clause 18 wherein the instrument comprises a first mass analyser for analysing a selected ion species.
20. The analytical instrument of clause 19 wherein the first mass analyser is a time-of-flight mass analyser and/or wherein the second mass analyser is an electrostatic orbital trapping analyser.
21. The analytical instrument of any of clauses 18 to 20 wherein the instrument comprises a second mass analyser used to perform the MS1 scan, wherein the second mass analyser is different to the time-of-flight mass analyser.

### BRIEF DESCRIPTION OF DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labelled in every figure.

FIG. 1A is a schematic drawing illustrating an analytical instrument;

FIG. 1B shows a schematic arrangement of a mass spectrometer suitable for carrying out methods in accordance with embodiments of the disclosure;

FIG. 2 shows two graphs showing the averaged Astral MS spectra of two analytes;

FIG. 3 shows four graphs showing Astral MS spectra with different levels of averaging;

FIG. 4 illustrates a method of operating a mass spectrometer in accordance with the disclosure;

FIG. 5 shows a trend of number of isotopic peaks with ion mass, and estimate of number of averages required to populate the isotopic envelope.

FIG. 6 illustrates a method of operating a mass spectrometer in accordance with the disclosure; and

FIG. 7 illustrates a known method of operating the mass spectrometer of FIG. 1B.

The invention will now be described in relation to specific embodiments. The embodiments described herein are not intended to be limiting and are for illustrative purposes.

### DETAILED DESCRIPTION OF PREFERRED EMBODIMENTS

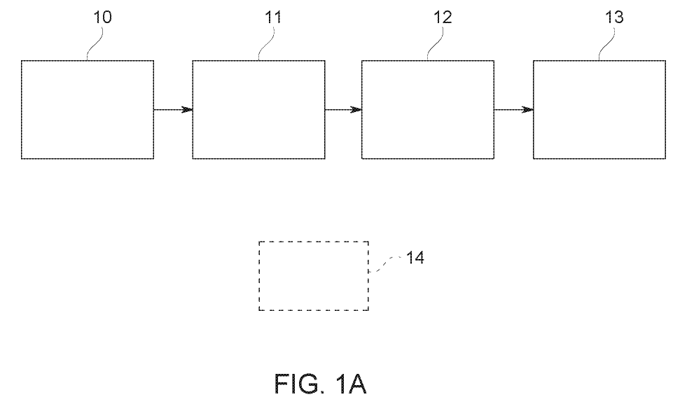

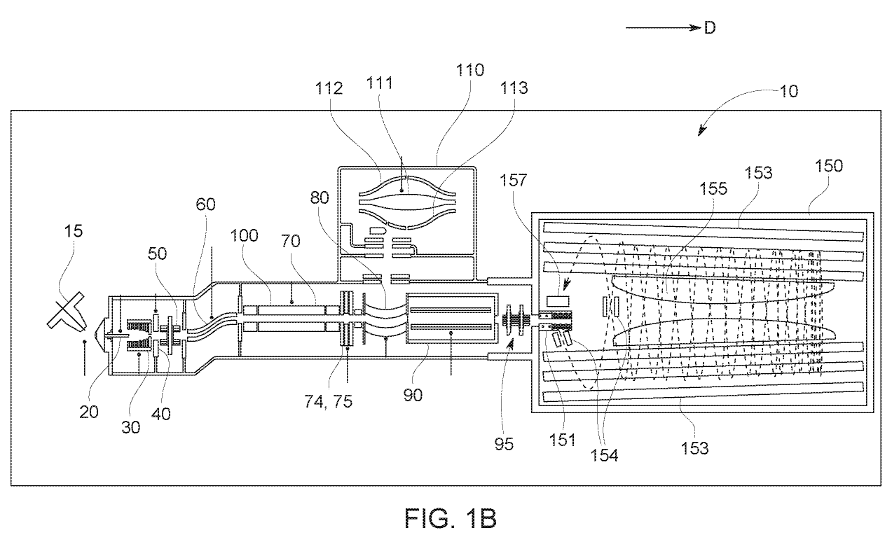

FIG. 1A illustrates schematically an analytical instrument, such as a mass spectrometer, that may be used in conjunction with the methods described herein. As shown in FIG. 1A, the instrument includes an ion source 10, a mass filter 11, a fragmentation device 12, and a mass analyser 13.

The ion source 10 is configured to generate ions from a sample. The ion source 10 can be any suitable ion source, such as an electrospray ionisation (ESI) ion source, an atmospheric pressure ionisation (API) ion source, a chemical ionisation ion source, an electron impact (EI) ion source, or similar. Numerous other types of ionisation are possible. The ions may be any suitable type of ions to be analysed, e.g. small and large organic molecules, biomolecules, DNA, RNA, proteins, peptides, fragments thereof, and the like.

The ion source 10 may be coupled to a separation device (not shown) such as a liquid chromatography (LC) separation device, a gas chromatography (GC) separation device, or a capillary electrophoresis separation device, and the like, such that the sample which is ionised in the ion source 10 comes from the separation device.

The analytical instrument may additionally or alternatively include an ion separation device (not shown) arranged downstream of the ion source and configured to separate samples ions according to a physico-chemical property. For example, the instrument may include an ion mobility (IM) separator, a differential ion mobility separator, or a device configured to separate ions according to their mass to charge ratio (m/z)).

The mass filter 11 is arranged downstream of the ion source 10 and is configured to receive ions from the ion source 10 (optionally via the ion separation device). The mass filter 11 is configured to filter the received ions according to their mass to charge ratio (m/z). The mass filter 11 may be configured such that received ions having m/z within an m/z transmission window (or “isolation window”) of the mass filter are onwardly transmitted by the mass filter, while received ions having m/z outside the m/z transmission window are attenuated by the mass filter, i.e. are not onwardly transmitted by the mass filter. The width and/or the centre m/z of the transmission window may be controllable (variable), e.g. by suitable control of RF and/or DC voltage(s) applied to electrodes of the mass filter 11. Thus, for example, the mass filter 11 may be operable in a transmission (“non-resolving”) mode of operation, whereby most or all ions within a relatively wide m/z window are onwardly transmitted by the mass filter 11, and a filtering mode of operation, whereby only ions within a relatively narrow m/z window (centred at a desired m/z) are onwardly transmitted by the mass filter 11. The mass filter 11 can be any suitable type of mass filter, such as a quadrupole mass filter.

The fragmentation device 12 is arranged downstream of the mass filter 11 and is configured to receive most or all ions transmitted by the mass filter 11. The fragmentation device 12 may be configured to selectively fragment some or all of the received ions, i.e. so as to produce fragment ions. The fragmentation device 12 may be operable in a fragmentation mode of operation, whereby most or all received ions are fragmented so as to produce fragment ions (which may then be onwardly transmitted from the fragmentation device 12), and a non-fragmentation mode of operation, whereby most or all received ions are onwardly transmitted without being (deliberately) fragmented. It would also be possible for a non-fragmentation mode of operation to be implemented by causing ions to bypass the fragmentation device 12. The fragmentation device 12 may also be operable in one or more intermediate modes of operation, e.g. whereby the degree of fragmentation is controllable (variable). The instrument can also be operable in higher order (MS^{N}) fragmentation modes of operation, e.g. whereby fragment ions are further fragmented one or more times by the fragmentation device 12.

The fragmentation device 12 can be any suitable type of fragmentation device, such as for example a collision induced dissociation (CID) fragmentation device, an electron transfer dissociation (ETD) fragmentation device, an electron induced dissociation (EID) fragmentation device, a photodissociation fragmentation device, and so on. Numerous other types of fragmentation are possible.

The mass analyser 13 is arranged downstream of the fragmentation device 12 and is configured to receive ions from the fragmentation device 12. Thus, the mass analyser 13 may receive unfragmented precursor ions and/or fragment ions, depending on the mode of operation of the fragmentation device 12. The mass analyser 13 is configured to analyse the received ions so as to determine their mass to charge ratio (m/z) and/or mass, i.e. to produce a mass spectrum of the ions. The mass analyser 13 can be any suitable type of mass analyser, such as a Fourier Transform (FT) mass analyser, an ion trap mass analyser, an electrostatic orbital trap mass analyser (such as an Orbitrap^{TM} FT mass analyser as made by Thermo Fisher Scientific), a time-of-flight (ToF) mass analyser such as a multi-reflecting time-of-flight (MR-ToF) mass analyser, or a quadrupole mass analyser. Numerous other types of mass analyser are possible.

It should be noted that FIG. 1A is merely schematic, and that the instrument can, and in embodiments does, include any number of one or more additional components such as ion optical devices. For example, the instrument may include one or more ion transfer stage(s) arranged between any of the illustrated components, e.g. including an atmospheric pressure interface and/or one or more ion guides, lenses and/or other ion optical devices configured such that some or all of the ions can be transmitted appropriately through the instrument. The ion transfer stage(s) may include any suitable number and configuration of ion optical devices, for example optionally including one or more ion guides, lenses and/or other ion optical devices.

In some embodiments, the instrument may include more than one mass analyser. For example, the instrument may be a dual mass analyser hybrid mass spectrometer of the type described in EP 3,410,463, the contents of which are incorporated herein by reference. Numerous other types of dual mass analyser hybrid mass spectrometer are possible.

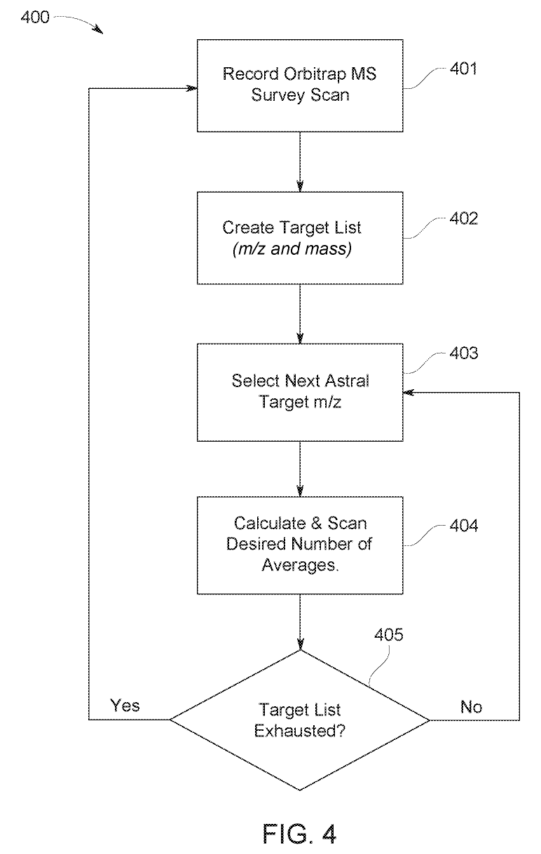

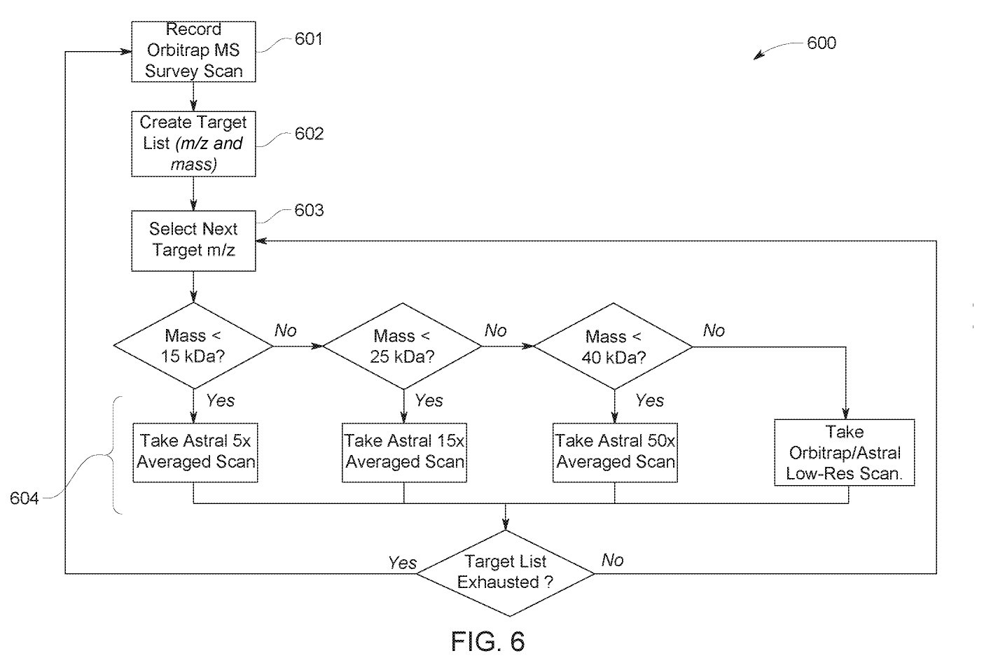

As also shown in FIG. 1A, the instrument is under the control of a control unit 14 (which may be denoted a controller), such as an appropriately programmed computer, which controls the operation of various components of the instrument and, for example, sets the voltages to be applied to the various components of the instrument. The control unit 14 may also receive and process data from various components including the analyser(s). The control unit may control the various elements of the analytical instrument in order to perform the method as described below, for example with reference to FIGS. 4 and 6. For instance, the control unit (or controller) may determine a target number of ions to be analysed, and initiate the performance of a plurality of mass analysis scans by the mass analyser.

The instrument may be operable in various modes of operation. In particular, the instrument may be a tandem mass spectrometer operable in an MS1 mode of operation and an MS2 mode of operation.

In the MS1 (or “MS”, “full mass scan”, or “survey scan”) mode of operation, the mass filter 11 is operated in its transmission mode of operation and the fragmentation device 12 is operated in its non-fragmentation mode of operation, e.g. so that a wide m/z range (e.g. full mass range) of unfragmented (“precursor” or “parent”) ions are analysed by the analyser 40 to produce an MS1 spectrum.

In the MS2 (or “MS/MS”) mode of operation, the mass filter 11 is operated in its filtering mode of operation and the fragmentation device 12 is operated in its fragmentation mode of operation, e.g. so that a selected narrow m/z range of precursor ions are fragmented and the resulting fragment (“product” or “daughter”) ions are analysed by the analyser 40 to produce an MS2 spectrum.

The instrument may also be operable in one or more higher order fragmentation mode of operation, such as for example an MS3 mode of operation, whereby precursor ions are fragmented, at least some of the resulting fragment ions are themselves fragmented, and the second-generation fragment ions (“granddaughter ions”) are analysed by the analyser 40 produce an MS3 spectrum. In general, the instrument may be operable in any order of fragmentation mode of operation, i.e. in an MS^{N} mode of operation where N≥2.

A method of operating the analytical instrument involves providing a sample to the chromatographic (e.g. LC or GC) separation device so that the sample is chromatographically separated, ionising the eluent from the chromatographic separation device in the ion source 10, and analysing the resulting ions. Different compounds within the sample experience different retention times (RT) within the chromatographic separation device and so elute from the chromatographic separation device (and are ionised) at different times. The chromatographic separation device typically takes a few tens of seconds or a few minutes to complete each chromatographic separation scan.

During each chromatographic separation scan, multiple MS2 spectra (or, more generally, multiple MS^{N} spectra) may be acquired by sequentially altering the centre of the mass filter’s (narrow) m/z window between each of a plurality of different m/z values, e.g. so as to sequentially select (and fragment) each of a plurality of different precursor ions with respective different m/z.

In a data dependent acquisition (DDA) mode of operation, the plurality of different m/z values may correspond to a plurality of different precursor ions identified from corresponding MS1 data (i.e. a full mass scan). Thus, a typical data dependent acquisition (DDA) method involves repeatedly performing, during a chromatographic separation scan, the steps of: (i) obtaining an MS1 spectrum across an m/z range of interest; (ii) identifying one or more precursor ions of interest in the MS1 spectrum; and (iii) obtaining an MS2 (or MS^{N}) spectrum in respect of each the identified precursor ions of interest. Step (iii) comprises, for each of the identified precursor ions: isolating the precursor ion using the mass filter 11, fragmenting the isolated precursor ions in the fragmentation device 12, and mass analysing the fragment ions using the mass analyser 13. In a so-called “Top-N” method, the precursor ions of interest identified in the MS1 spectrum are the precursor ions corresponding to the N most intense peaks in the MS1 spectrum.

In a data independent acquisition (DIA) MS2 (or MS^{N}) mode of operation, the plurality of different m/z values may be taken from a predetermined (fixed) list, i.e. without reference to MS1 data. For example, a narrow m/z isolation window may be sequentially stepped across the entire m/z range of interest, e.g. as described in EP 3,410,463.

The instrument may be operated such that successive batches of ions from the ion source 10 are each accumulated, optionally processed, and then mass analysed by mass analyser 13 (as used herein, the accumulation of a batch of ions, its optional processing, and its subsequent ejection into and analysis by the mass analyser is termed a mass analysis “scan”). The sequence of mass analysis scans can be parallelised, e.g. by accumulating and optionally processing a batch of ions at the same as the previous batch of ions is being analysed by the mass analyser.

It is desirable that each batch of ions analysed by the mass analyser 13 includes as many ions as possible, so as to improve the statistics of the mass spectrum. However, undesirable space charge effects can occur at relatively high ion concentrations and can limit mass resolution and mass accuracy. Therefore, the total number of ions accumulated is controlled to optimise the number of ions injected into the mass analyser 13 to be below, but as close as possible to, a limit such as a space-charge limit for an ion trap and/or for the mass analyser 13. Typically, between 1e4 and 1e6 elementary charges should be stored, such as between 1e5 and 5e5.

Therefore, the instrument can use so-called automatic gain control (AGC) techniques to precisely control the total number of ions accumulated in the ion trap. These techniques typically rely on a real-time estimation of the present ion current J or ion flux being received by the ion trap. Then, by controlling the injection time Tf of ions into the ion trap, the total number of ions or the total amount of charge accumulated in the trap (and injected into the mass analyser 13) can be suitably controlled.

Thus, a batch of ions that is to be injected into the mass analyser 13 is first stored in the ion trap, where its total charge Q = J*Tf can be determined by the ion trap injection time Tf during which the ion trap receives an ion current J from the ion source 10. The injection time (e.g. fill time) of ions in the trap is adjusted based on an estimation of the present ion current J or ion flux to control the total number of ions accumulated in the ion trap. In this way, the total number of ions injected into the mass analyser 13 per scan can be controlled in order to achieve an appropriate signal-to-noise ratio while avoiding adverse space-charge effects caused by the ion trap and/or analyser overfilling.

FIG. 1B shows a schematic arrangement of a mass spectrometer that may be operated in accordance with embodiments of the present disclosure. It will be understood that the instrument shown in FIG. 1B is a non-limiting example, and that numerous variations are possible.

The instrument of FIG. 1B comprises an ion source 15, ion transfer stages 100, an initial mass analyser 110, an extraction trap 151, and a downstream mass analyser 150.

The ion source 15 is configured to generate ions from a sample. The ion source 15 can be a continuous or pulsed ion source, such as an electrospray ionisation (ESI) ion source, a MALDI ion source, an atmospheric pressure ionisation (API) ion source, a plasma ion source, an electron ionisation ion source, a chemical ionisation ion source, and so on. More than one ion source may be provided and used. The ions may be, e.g. small and large organic molecules, biomolecules, DNA, RNA, proteins, peptides, fragments thereof and the like.

The ion source 15 may be coupled to a separation device such as a liquid chromatography separation device or a capillary electrophoresis separation device (not shown), such that the sample which is ionised in the ion source 15 comes from the separation device.

The ion transfer stages 100 may be positioned downstream of the ion source 15 and upstream of the extraction trap 151. The ion transfer stages 100 may comprise a capillary 20, an ion funnel 30, a calibrant source 40, a quadrupole pre-filter 50, an ion guide 60, a quadrupole mass filter 70, a charge detector 75, a curved linear ion trap (C-trap) 80, a collision cell 90, and a multipole ion guide 95. The ion guide 60 may be of the design described in US patent No. 9,536,722.

The collision cell 90 may be in the form of an ion routing multipole collision cell (“IRM”).

Ions from the ion source may be accumulated in the C-trap 80 and/or the collision cell 90 by opening and closing an ion gate 74 located within the charge detector 75. The charge detector 75 may be positioned between quadrupole mass filter 70 and the C-trap 80.

Optionally, the initial mass analyser 110 is an electrostatic orbital trap mass analyser. An example of such a mass analyser is the Orbitrap® mass analyser sold by Thermo Fisher Scientific, Inc. As shown in FIG. 1B, the initial mass analyser 110 may comprise an inner electrode 111 elongated along the orbital trap axis and a split pair of outer electrodes 112, 113 which surround the inner electrode 111 and define therebetween a trapping volume in which ions are trapped and oscillate by orbiting around the inner electrode 111, to which is applied a trapping voltage, whilst oscillating back and forth along the axis of the trap. The pair of outer electrodes 112, 113 function as detection electrodes to detect an image current induced by the oscillation of the ions in the trapping volume and thereby provide a detected signal.

The outer electrodes 112, 113 typically function as a differential pair of detection electrodes and are coupled to respective inputs of a differential amplifier (not shown in FIG. 1B), which in turn forms part of a digital data acquisition system to receive the detected signal. The detected signal can be processed using Fourier transformation to obtain a first mass spectrum of ions within the initial mass analyser 110.

Once accumulated in the ion trap 80 and/or collision cell 90, ions can be injected into the initial mass analyser 110. To do this, the ions may be ejected from the trap 80 in a direction orthogonal to the axis of the trap (orthogonal ejection), for example, by applying one or more suitable DC voltages to the ion trap 80. The ions may be injected into the mass analyser 110 via one or more lenses and a deflector electrode.

Optionally, the downstream mass analyser 150 is an ion trap time-of-flight (IT-ToF) mass analyser. An example of such a mass analyser is the Astral^{TM} mass analyser sold by Thermo Fisher Scientific, Inc. The IT-ToF mass analyser may be a multiple reflection time-of-flight mass analyser (mr-ToF), e.g. as described in US patent no. 9,136,101. The mr-ToF mass analyser 150 is constructed around two opposing ion mirrors 153, elongated in a drift direction D. The mirrors are opposed in a direction that is orthogonal to the drift direction. The extraction trap 151 injects ions into a first mirror of the two mirrors 153 and the ions then oscillate between the two mirrors 153. The angle of ejection of ions from the extraction trap 151 and additional deflectors 154 allow control of the energy of the ions in the drift direction, such that ions are directed down the length of the mirrors 153 as they oscillate, producing a zig-zag trajectory. The mirrors 153 themselves are tilted relative to one another, producing a potential gradient that retards the ions' drift velocity and causes them to be reflected back in the drift dimension and focused onto a detector 157. The tilting of the opposing mirrors would normally have the negative side-effect of changing the time period of ion oscillations as they travel down the drift dimension. This can be corrected using a stripe electrode 155 (to act as a compensation electrode) that alters the flight potential for a portion of the inter-mirror space, varying down the length of the opposing mirrors 153. The combination of the varying width of the stripe electrode 155 and variation of the distance between the mirrors 153 allows the reflection and spatial focusing of ions onto the detector 157 as well as maintaining a good time focus.

The downstream mass analyser 150 is configured to operate with a repetition period T_{R}. During each repetition period, a packet of ions is mass analysed by the mass analyser, and at the same time a new packet of ions is accumulated in the extraction trap 151. The repetition period T_{R} of the downstream mass analyser 150 may be defined primarily by the time taken for an ion packet to be accumulated in the extraction trap 151 and ejected into the mass analyser. Furthermore, it may be necessary to operate the ejection trap 151 in a non-accumulating mode for some minimum amount of time during each repetition period (e.g. to allow time for accumulated ions to be processed, etc.). The repetition period should, of course, also be long enough to allow each packet of ions to be mass analysed (i.e. to allow the ions to traverse the mass analyser, reach the detector 157, and for the data to be analysed for a mass spectrum to be produced), but the mass analysis of a packet of ions typically requires less time than is needed for its accumulation.

In some embodiments, the downstream analyser 150 has a repetition period of 5 ms or less. The repetition period is the inverse of the repetition rate, which is the number of mass spectra acquired by the downstream analyser 150 per second. In some embodiments, the downstream analyser 150 has a repetition rate of 200 Hz or more.

The extraction trap 151 may be an ion processor as described in US patent no. 9,548,195. The extraction trap 151 is provided to form an ion packet of ions prior to injection into the ToF mass analyser 150. The extraction trap 151 accumulates ions over an accumulation time, allowing the continuous beam of ions from the ion source to be transformed into a concentrated ion packet. The accumulation time may be controlled by the ion gate 74. The ion gate 74 may be located in the charge detector assembly 75. After the accumulation time has elapsed, the accumulated ion packet is ejected as a pulse from the extraction trap 151 into the ToF mass analyser 150. The ejection may occur significantly quickly such that it much shorter than the accumulation time.

The extraction trap 151 may contain a buffer gas and incorporate two trapping regions, a first region at a first pressure for rapid ion cooling, and a second region at a second pressure for ion extraction. The first pressure is higher than the second pressure. Ions are cooled in the high-pressure first region and then transferred to the low-pressure second region, where they are pulse ejected into the ToF analyser. The pulse ejection may involve applying a DC voltage to the extraction trap 151.

In some embodiments, when operating the analytical instrument of FIG. 1B in a DDA or DIA mode of operation, MS1 scans may be acquired using the initial mass analyser, and MS2 scans may be acquired using the downstream mass analyser.

Although the mass spectrometer depicted in FIG. 1B is particularly suitable, it will be understood that numerous alternative mass spectrometer configurations are possible. For example, although in FIG. 1B, the ToF mass analyser is of a tilted-mirror type as described in US patent No. 9,136,101, it will be understood that any type of ToF analyser could be used. For example, the analyser may be a single-lens type multireflection time-of-flight mass analyser, e.g. as described in UK Patent No. GB 2,580,089, a linear ToF mass analyser, an orthogonal acceleration ToF mass analyser, a reflectron ToF mass analyser, a closed-loop multi-reflection mass analyser, another type of multi-reflection time-of-flight (MR-ToF) analyser, etc. In the instrument depicted in FIG. 1B, the two mass analysers are in the form of a ToF mass analyser and an orbital ion trap mass analyser, but in general any type or types of mass analyser could be provided.

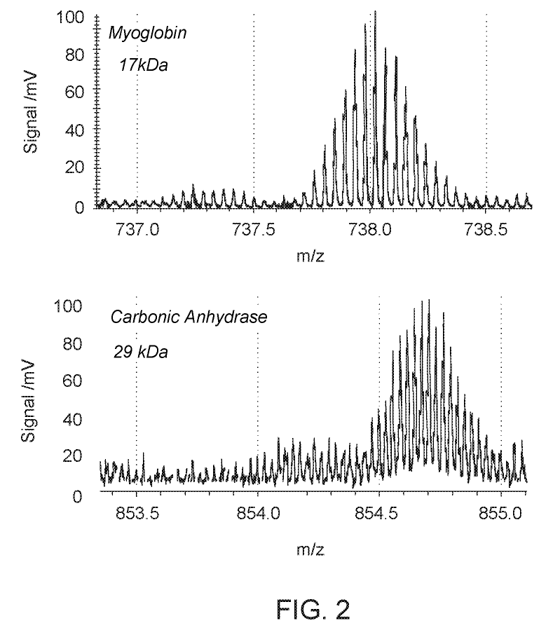

Intact protein ions and their larger fragments, through high mass, split signal between a large number of isotopes (and small neutral loss products), requiring large amounts of measured charges to properly analyse. This issue is made worse by collisional scatter, which causes ions to arrive at distorted time-of-flight, effectively creating random noise signals around peaks. FIG. 2 shows a 100 times averaged Astral MS spectra of 17 kDa (kilodalton) Myoglobin and the heavier 29 kDa Carbonic Anhydrase proteins. As shown in FIG. 2 which shows signal/mV against m/z ratio, there is more of a problem with larger, heavier ions which have more chemical noise around their more complex peaks. It has been realised herein that analytes with a greater mass would benefit from a greater number of averages, whereas analytes with a lower mass would require less averages.

It will be understood that a greater number of averages means a greater number of mass analysis scans over which an average is calculated, and consequently the analysis of a greater total number of ions across the various mass analysis scans. The detector sensitivity is substantially constant and independent of the mass of the ions to be analysed (with an estimated <90% ions being detected during each analysis scan). The number of ions analysed per individual mass analysis scan is largely invariant to the mass of the selected ion to be analysed. Increasing the number of mass analysis scans increases the total number of ions analysed. Therefore, if an increase to a target number of ions to be analysed is desired, then an implementation option includes increasing the number of mass analysis scans, thereby causing the number of mass analysis scans required to analyse the target number of ions to be proportional to the mass of the selected ion, in turn.

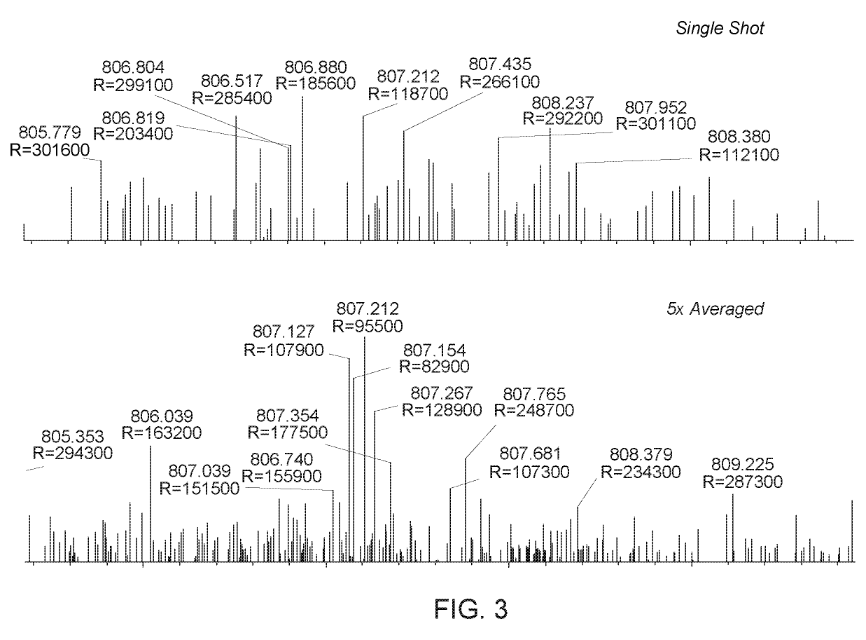

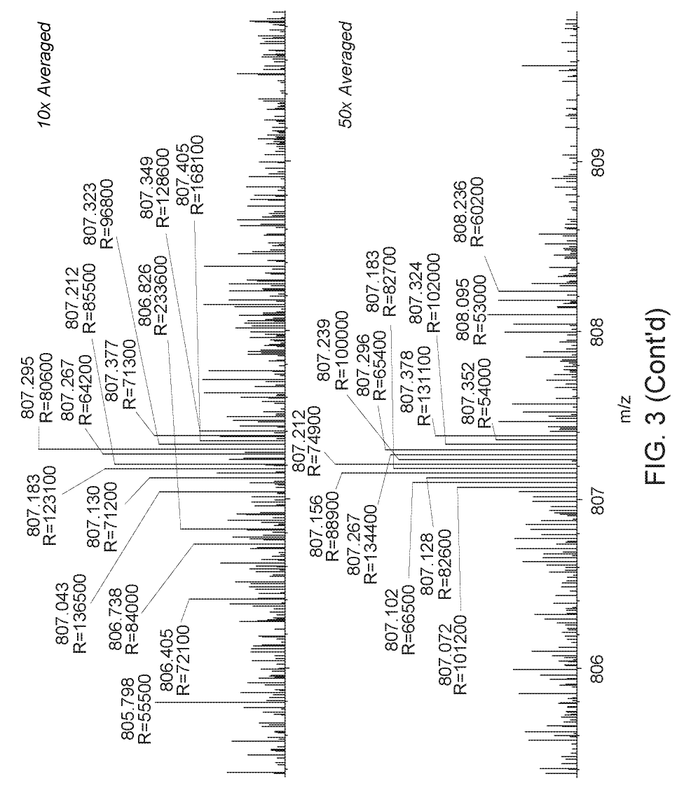

FIG. 3 shows an Astral MS spectra of myoglobin m/z 738 isotopic envelope with different levels of averaging. The results from a single shot, 5 times averaged, 10 times averaged and 50 times averaged are shown. As shown, increasing averaging builds up a myoglobin isotopic envelope, which becomes well defined at around 50x averaging. With good AGC control, 10x averaging is thought sufficient for this 17 kDa species (though perhaps with greater numbers of ions per shot as used in FIG. 3), but as mentioned in relation to FIG. 2, greater masses require greater numbers of averages to elucidate. In some examples, the Top-Down DDA (data dependent acquisition) may use the Orbitrap analyser to make the full-MS scans, paired with fast Astral analyser MS/MS where the heavy proteins ions have been fragmented. However, this still requires analysis of very large fragments.

FIG. 4 illustrates a method 400 according to embodiments of performing an analysis of a sample using an instrument such as that shown in FIG. 1B. The method may involve firstly carrying out an initial scan (e.g. a full mass scan, or MS1 scan), optionally in the initial mass analyser 110. In data dependent acquisition, the initial scan may be used to provide measurement information about precursor ions. The MS1 scan may provide a measurement of the ions (optionally filtered by mass to charge ratio (m/z)) provided from the ion source 15 (i.e., an MS1 spectrum).

Thus, in step 401 of method 400, an MS1 scan is performed to provide measurements of ions provided from the ion source.

In step 402 a target list may be created using the results of the MS1 scan. The target list may comprise one or more ion species (i.e. target ions) for analysis by the mass spectrometer. The target list may include the mass and mass to charge (m/z) ratio of each species of ion for analysing.

In step 403 an ion species is selected from the list, and in step 404 a target number of ions is calculated based on the mass of the ion species selected in step 403. The target number of ions is defined as the number of ions required to provide a comprehensive analysis of the sample. The number of ions (or number of charges) required to be analysed may change based on the mass of the specific ion species (analyte) and therefore in step 404 the number of ions for analysing is calculated based on the mass of the species as determined from the MS1 scan. Ion species with greater mass have a higher target ion number, and ion species with a lower mass have a lower target ion number. In other words, the target number of ions increases with selected ion species mass. The target number of ions may increase in a continuous or stepped manner, as will be described in more detail herein. In certain examples, the target number of ions may be a target number of ions of the specific ion species selected (analyte).

The target number of ions is distributed amongst a plurality of mass analysis scans, e.g. MS2 scans. Each of the plurality of mass analysis scans may have a predetermined maximum accumulation time, and therefore the number of mass analysis scans may also be dependent on target ion number, and so on the mass of the selected ion species in turn. Therefore, ion species with a greater mass may require a greater number of mass analysis scans over which to analyse the ion species. In other words, in step 404 the number of scans may be calculated based on the mass of the selected ion species. In step 404 the calculated number of MS2 scans are performed and the resulting mass spectra are then processed to a single mass spectrum. This may be done by summing the mass spectra, averaging the mass spectra, or taking a weighted sum of the mass spectra. The resulting mass spectrum can have improved dynamic range over a mass spectrum taken using a single ion packet accumulated over the original desired accumulation time.

The method is repeated until each of the ion species within the target list has been scanned and averaged to provide a result for each selected ion species. Therefore, at step 405, it may be determined whether the target list of ions has been exhausted, i.e. whether the ion species selected in step 403 was the last ion species on the target list of ions. If the target list has not been exhausted, after step 405 the method continues to step 403, in which a next (e.g. second, third, etc.) ion species is selected for analysis.

The second ion species, for example, may have a second mass, and may have a second m/z ratio. The second mass may be different to the first mass. A second target number of ions is determined based on the second mass, where the second target number of ions may be different from the first target number of ions. A second plurality of mass analysis scans may be performed to analyse the second ion species, wherein the second target number of ions is distributed amongst the second plurality of mass analysis scans. The number of mass analysis scans performed to analyse the second ion species may be different from the number of mass analysis scans performed to analyse the first ion species.

If the target list has been exhausted, the method may continue to step 401 in which an MS1 scan is performed to determine updated measurements of ions from an ion source, where the measurements of ions may have changed. Therefore, an updated target list may be created and the method repeated.

In some examples, the number of averages may be calculated reactively (i.e. in real-time). For example, the first one or more shots may be analysed in real time to detect signs of high mass / highly multiply charged ions, and a decision may be taken to record further averages based on the presence of such ions. Therefore, the averaging may be controlled dynamically without requiring a prior estimate of ion charge states. For example, peaks may be filtered by width to determine the presence of intense single ions (these are typically much narrower than multi-ion peaks), where the intensities of these may give an indication of charge state and thus mass (at known m/z) by themselves. Few multiple ion peaks may indicate that more averages are needed. The instrument might also report if species in the precursor window have sufficient quality to determine charge state.

In some examples of the methods described herein, a pre-scan (e.g. MS1 scan) or a preceding full-MS scan might also or instead be used to estimate the dominant mass or charge state of ions in an upcoming full-MS scan, whether using an Orbitrap analyser or ToF analyser, and to adjust parameters. For example, such parameters may include one or more of: inject time; level of averaging; and/or detector gain.

In some examples of the methods described herein, different scans may be combined, where a second type of scan may be performed between multiple scans of a first type. For example, multiple Astral analyser scans may be carried out in combination with multiple Orbitrap analyser scans. In one illustrative example, one Orbitrap analyser scan may be performed, followed by a set of multiple (e.g. 20) Astral analyser scans, followed by a second Orbitrap analyser scan, which may be followed by another set of multiple (e.g. 20) Astral analyser scans (and so on). The results of all the multiple (e.g. 40) Astral analyser scans may then be averaged. In some examples the results of the multiple Orbital analyser scans may be averaged together, or may be analysed individually. Interspersing different scan types has the advantage that it is possible to process data from a first scan type while a second scan type is being acquired, and to then decide whether further scans of the first type should be taken (and their results averaged). In this example, data from the first scan type (e.g. one or more Orbitrap analyser scan(s)) may be processed whilst one or more scan(s) of the second type (e.g. one or more Astral analyser scan(s)) is/are performed, providing time to determine whether one or more second scan(s) of the first type is/are required, such that the results from the first and second scans of the first type may be averaged.

Additionally or alternatively, scans using the same analyser targeting different precursor ions may be interspersed. For example, one or more scan(s) measuring an MS/MS spectra of a first ion species (e.g. m/z 100) may be performed, followed by one or more MS/MS scan(s) measuring a second ion species (e.g. m/z 200), and then by one or more further scan(s) for the first ion species (e.g. m/z 100). In this case, the results from the scans for the first ion species (e.g. m/z 100) may be averaged. Interspersing scans for different ion species (of different m/z) again has the advantage that it is possible to process data from one scan or one set of scans and to then decide whether further averages are needed. In this example, data from the first (e.g. 100 m/z) scan(s) may be processed whilst the next (e.g. 200 m/z) scan(s) is/are performed, providing time to determine whether further scan(s) for the first ion species (e.g. at 100 m/z) is/are required, such that the results from the first and second scans for the first ion species (e.g. at 100 m/z) may be averaged.

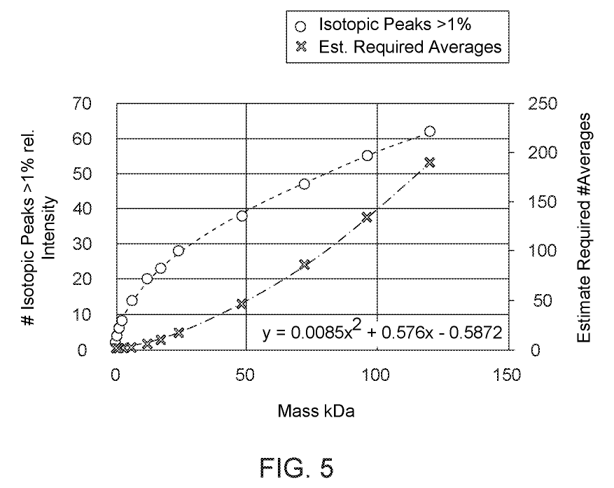

FIG. 5 shows a trend of the number of isotopic peaks having greater than 1% relative intensity with ion mass, and an estimate of the number of averages required to populate the isotopic envelope. The number of significant isotopic peaks (>1% rel. intensity) increases in a known manner with mass, where this is shown for purely carbon molecules in FIG. 5. The number of charges required to populate this distribution, at ~10 ions per peak and charge state at m/z 1000 can then be calculated and the minimum number of averages consequently estimated. FIG. 5 shows this rough estimate, normalized to the 10x averaging known to give reasonable results for 17kDa Myoglobin, and it can be seen that the estimated number of averages in this example is both roughly quadratic and rapidly increases with mass. Therefore, shown in FIG. 5, the target ion number may increase in a continuous manner, and methods herein may calculate the target number of ions for analyzing using a function by which the target number of ions increases in a continuous manner with increasing mass of selected ion species. This estimate shown in FIG. 5 does not account for collisional scatter, which may further increase the rate at which the number of averages increases with mass.

An alternative method 600 for DDA analysis, according to embodiments, is shown in FIG. 6. The method may comprise some or all of the same method steps as method 400 described herein. As described in relation to FIG. 6, the target number of ions, and the number of mass analysis scans, may increase in a stepwise manner with increasing selected ion species mass.

In step 601 of method 600, an MS1 scan is performed to provide measurements of ions provided from the ion source.

In step 602 a target list may be created using the results of the MS1 scan. The target list may comprise one or more ion species (i.e. target ions) for analysis by the mass spectrometer. The target list may include the mass and mass to charge (m/z) ratio of each species of ion for analysing.

In step 603 an ion species is selected from the list, and is sorted into one of a plurality of bins, wherein each of the bins is associated with a range of masses. Therefore, the bins can each instead be referred to as a mass range. By sorting the selected ion species into one of the plurality of bins, each of the target ion species in the target list is filtered by mass.

In the example shown in FIG. 6, there are four bins. A first bin is for selected ions with mass less than 15 kDa. The second bin is for selected ions with mass between 15kDa and 25kDa. The third bin is for selected ions with mass between 25 kDa and 40 kDa. If the selected ion species has mass greater than 40 kDa, then this falls into the fourth bin. In this example, ions with mass greater than 40 kDa undergo a low resolution Orbitrap analyser scan or a low-resolution Astral analyser scan.

Therefore, the method comprises determining a mass above which a low-resolution scan would provide a better result than a high-resolution scan.

The first, second, and third bins have different levels of averaging. In step 604 the selected ion species is averaged according to their bin. In other words, the selected ion species is averaged according to the mass range into which they fit.

In this example, for ions with a mass less than 15 kDa, 5 mass analysis scans are performed. For ions with mass between 15 kDa and 25 kDa, 15 mass analysis scans are performed. For ions with mass between 25k Da and 40 kDa, 50 mass analysis scans are performed. Therefore, the number of mass analysis scans are determined based on the mass of the selected ion species.

After averaging the selected ion species according to its mass, it is determined whether the target list has been exhausted, i.e. whether each ion species in the list has been analysed. If the list has been exhausted, the method continues to step 601 to perform another MS1 scan and the method 600 is repeated. If the list has not been exhausted, the method continues to step 603 in which another target is selected from the list.

The method of using bins to filter and assign numbers of averages to each selected ion species has the advantage that no calculations are required. Instead, the ranges may be predetermined, and the number of scans and averages is determined based on the mass of the selected ion species.

In another example, the selected ion could be filtered into bins by m/z and charge state filters. The remaining steps of the method would follow the same technical considerations.

In some examples, the accumulation time per scan may be constant, i.e. the accumulation time is the same for each scan. In other examples, the methods described herein may be combined with automatic gain control (AGC) to control the accumulation time per scan. Therefore, the method may comprise controlling the inject time per scan, and an overall required inject time (i.e. the time required to inject the target number of ions) to determine the number of scans. In this example, each of the plurality of mass analysis scans may have an individual target accumulation time, where the individual target accumulation time may be less than or equal to the maximum accumulation time. The individual target accumulation time may be determined based on automatic gain control (AGC) methods known to those skilled in the art. The individual target accumulation time may be based on charge of the selected ion species, such that the analyser is not overloaded. Therefore, the individual accumulation time may be determined by the capacity of the analyser, or it’s injection system. For example, the Astral mass analyser’s ion trap described herein may have a capacity of 30,000 charges. In other words, the individual target accumulation time may instead be considered with reference to a predetermined charge capacity. The number of averages required may be estimated for a given mass and/or charge of analyte. The number of averages may increase with an increase of mass of analyte following a linear or quadratic relationship, or it may follow a higher order polynomial or exponential relationship. The calculation of an overall AGC target may also follow these trends. When considering the charge of an analyte ion, the number of averages may increase with an increase of charge of an analyte ion. This relationship between charge and number of averages is due to the fact that high charge states mean that the ion capacity of a single scan is reduced, as they have a limited charge capacity.

In the examples in which the target accumulation time is mass dependent, the precursor ions may be queued by the ratio of intensity to target accumulation time, or by the required accumulation time. It will be appreciated that this is different to conventional methods of DDA in which precursors are queued by intensity.

In some examples, embodiments may be considered in terms of a target amount of charge instead of a target number of ions, wherein any one or more of the methods described herein may be used to reach said target amount of charge using the novel techniques described herein.

In some examples, the detector gain of the mass analyser may be varied based on the mass of the selected ion species to prevent detector saturation. For example, the detector gain may be reduced for higher mass analytes. Multiply charged ions produce more intense single ion peaks (as more charge per ion gives more signal), so reducing the gain for high mass ions can reduce the single ion peak intensity and compensate somewhat for this effect.

In some examples described herein, the collisional energies used for one or more of the plurality of mass analysis scans may differ from collisional energies used for another one or more of the plurality of mass analysis scans. As higher collision energy will result in lower charge state product ions, the single-shot AGC target or another parameter such as detector gain may be varied appropriately. For example, where a relatively high collision energy is used to generate many singly charged relatively small fragments, a higher detector gain might be useful for that MS/MS scan.

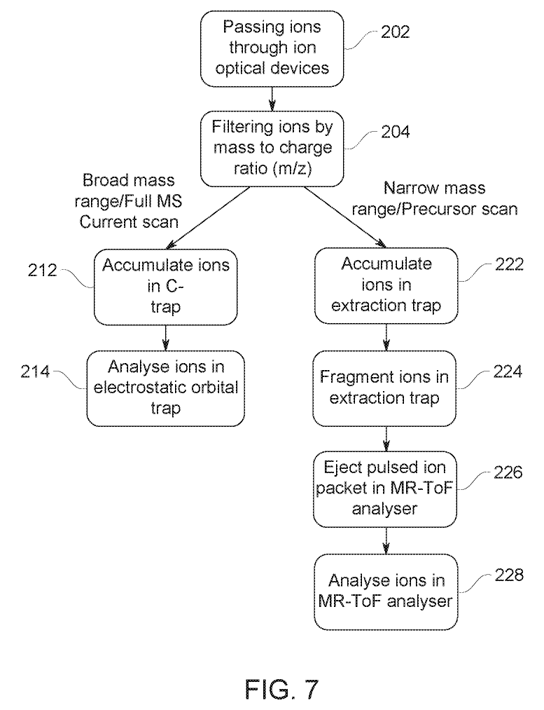

FIG. 7 illustrates a method of performing an analysis of a sample using an instrument such as that shown in FIG. 1B. The method may involve firstly carrying out an MS1 (e.g., a full mass scan) in the initial mass analyser 110, and then carrying out an MS2 scan in the downstream mass analyser 150. The MS1 scan provides a measurement of the ions (optionally filtered by mass to charge ratio (m/z)) provided from the ion source 15 (i.e., an MS1 spectrum). Generally, each MS2 mass analysis scan comprises: isolating the selected ion species; fragmenting the isolated ions to produce fragment ions; and mass analysing the fragment ions.

In more detail, during the MS2 scan, the instrument filters the ions supplied from the ion source 15 to provide a range of precursors filtered by mass to charge ratio (m/z). The filtered precursors are fragmented, and the resulting fragment ions are analysed in the downstream mass analyser 150 to provide a measurement of the ions (i.e., an MS2 spectrum).

In step 202, ions are passed through various ion transfer stages 100, such as those in FIG. 1B. Among these are mass filters, such as the quadrupole pre-filter 50 and the quadrupole filter 70. The ions are passed through the mass filter and filtered by mass to charge ratio (m/z) (step 204). When completing an MS1 scan, the range of ion masses allowed through the quadrupole filter 70 is generally broader than that of an MS2 scan.

When completing an MS1 scan, the ions are accumulated and cooled in the C-trap 80 in step 212, and then ejected orthogonally into the electrostatic orbital trap or Orbitrap^{TM} mass analyser 110 for analysis in step 214. The Orbitrap^{TM} mass analyser MS1 scan may take a few hundred milliseconds (ms), such as approximately 250 ms.

When completing an MS2 scan, the ions pass through the C-trap 80 and then pass through a multipole ion guide 95 and into the extraction trap 151 where they are accumulated in step 222. In step 224, ions are fragmented in the high pressure region of the extraction trap 151. The ions accumulate in the extraction trap 151 for a time determined by an ion gate 75 upstream of the trap, for example, the ion gate 75 may be within a charge detector 74 positioned between the quadrupole filter 70 and the C-trap 80. The accumulated ions are ejected as a pulse from the extraction trap 151 into the ToF mass analyser 150 by applying extraction voltages to electrodes of the extraction trap 151 in step 226. The ion packet is then analysed in the downstream analyser 150 in step 228.

The method of determining the target number of ions, and thus number of mass analysis scans is applied in this example to an ion trap time of flight mass analyser, however, it may be applied to alternative mass analysers, including but not limited to analytical ion traps and Fourier transform analysers.

Whereas FIG. 1B involves the use of an ion extraction trap 151, in fact the method and apparatus can, more generally, use any form of ion storage device in place of the ion extraction trap 151, such as: an ion trap (more generally); an ion accumulation device; an ion trapping region; an analytical ion trap; an orthogonal accelerator; a fragmentation cell; a reaction cell and/or collision cell, or any combination thereof.

In some embodiments, ions could be accumulated in one or more ion storage devices upstream of an extraction trap (or equivalent) for injection into the analyser.

In some embodiments, ions may be accumulated in both an extraction trap and in an ion storage device upstream of the extraction trap, e.g. by pre-accumulating ions in the upstream ion storage device, transferring the pre-accumulated ions from the upstream ion storage device to the extraction trap, and then accumulating additional ions in the extraction trap. In these embodiments, the accumulation time may correspond to the sum of the pre-accumulation time in the upstream ion storage device and the additional accumulation time in the extraction trap.

Whereas FIG. 1B depicts specific types of initial mass analyser 110 and downstream mass analyser 150, only one mass analyser is necessary, and other types of mass analyser(s) may be provided.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

It will be appreciated that there is an implied “about” prior to temperatures, concentrations, times, pressures, flow rates, cross-sectional areas, voltages, currents, etc. discussed in the present teachings, such that slight and insubstantial deviations are within the scope of the present teachings. Furthermore, values referred to as being “equal” may in fact differ by less than a threshold amount. The threshold amount may be 5%, for example. The threshold may also be greater than 5% (for example, 10%, 20% or 50%) or less than 5% (for example, 2% or 1 %).

As used herein, including in the claims, unless the context indicates otherwise, singular forms of the terms herein are to be construed as including the plural form and vice versa. For instance, unless the context indicates otherwise, a singular reference herein including in the claims, such as "a" or "an" means "one or more".

Throughout the description and claims of this disclosure, the words "comprise", "including", "having" and "contain" and variations of the words, for example "comprising" and "comprises" or similar, mean "including but not limited to", and are not intended to (and do not) exclude other components. Also, the use of “or” is inclusive, such that the phrase “A or B” is true when “A” is true, “B is true”, or both “A” and “B” are true.

The use of any and all examples, or exemplary language ("for instance", "such as", "for example" and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

The terms “first” and “second” may be reversed without changing the scope of the invention. That is, an element termed a “first” element may instead be termed a “second” element) and an element termed a “second” element may instead be considered a “first” element.

Any steps described in this specification may be performed in any order or simultaneously unless stated or the context requires otherwise. Moreover, where a step is described as being performed after a step, this does not preclude intervening steps being performed.

It is also to be understood that, for any given component or embodiment described herein, any of the possible candidates or alternatives listed for that component may generally be used individually or in combination with one another, unless implicitly or explicitly understood or stated otherwise. It will be understood that any list of such candidates or alternatives is merely illustrative, not limiting, unless implicitly or explicitly understood or stated otherwise.

In this detailed description of the various embodiments, for the purposes of explanation, numerous specific details are set forth to provide a thorough understanding of the embodiments disclosed. One skilled in the art will appreciate, however, that these various embodiments may be practiced with or without these specific details. Furthermore, one skilled in the art can readily appreciate that the specific sequences in which methods are presented and performed are illustrative and it is contemplated that the sequences can be varied and still remain within the scope of the various embodiments disclosed herein.

Unless otherwise described, all technical and scientific terms used herein have a meaning as is commonly understood by one of ordinary skill in the art to which the various embodiments described herein belongs.

1. A method of operating an analytical instrument for analysing ions, the method comprising:
selecting an ion species for analysis, the selected ion species having a mass;
determining a target number of ions to be analysed based on the mass of the selected ion species, wherein the target number of ions increases with increasing mass of the selected ion species; and
performing a plurality of mass analysis scans to analyse the selected ion species, wherein the target number of ions is distributed amongst the plurality of mass analysis scans.

2. The method of claim 1, wherein the target number of ions to be analysed increases in a continuous or stepped manner.

3. The method of claim 1, wherein the number of mass analysis scans performed to analyse the selected ion species is based on the mass of the selected ion species.

4. The method of claim 1, wherein determining a target number of ions to be analysed based on the mass of the selected ion species comprises determining a number of mass analysis scans required to analyse the target number of ions, wherein the target number of ions to be analysed is based on the mass of the selected ion species.

5. The method of claim 3, wherein each of the plurality of mass analysis scans has a predetermined maximum accumulation time such that the number of mass analysis scans performed to analyse the selected ion species is based on the mass of the selected ion species.

6. The method of claim 1, wherein each mass analysis scan produces a result and wherein the method comprises taking an average, sum, or weighted sum of the results produced by the plurality of mass analysis scans

7. The method of claim 1, further comprising limiting the number of scans in the plurality of scans based on a predetermined maximum number.

8. The method of claim 1, wherein each of the plurality of mass analysis scans comprises:
accumulating ions in an ion storage device, and injecting the accumulated ions as a pulse into a mass analyser for mass analysis.

9. The method of claim 1, wherein each of the plurality of mass analysis scans has an individual target accumulation time.

10. The method of claim 1, wherein the instrument comprises a time-of-flight mass analyser, wherein analysis of the selected ions species is performed using the time-of-flight mass analyser.

11. The method of claim 1, wherein each mass analysis scan is an MS2 mass analysis scan, and wherein each MS2 mass analysis scan comprises:
isolating the selected ion species;
fragmenting the isolated ions to produce fragment ions; and
mass analysing the fragment ions.

12. The method of claim 1, further comprising, before the step of selecting an ion species for analysis, performing an MS1 scan to determine the mass of the ion species that is to be selected for analysis.

13. The method of claim 12, further comprising determining a plurality of ion species for analysis from the MS1 scan, wherein the ion species for analysis is selected from the plurality of ion species for analysis.

14. The method of claim 1, wherein the selected ion species is a first ion species having a first mass, wherein the target number of ions is a first target number of ions to be analysed, wherein the plurality of mass analysis scans is a first plurality of mass analysis scans, and wherein the method further comprises:
selecting a second ion species for analysis, the second ion species having a second mass which is different from the first mass;
determining a second target number of ions to be analysed based on the second mass, wherein the second target number of ions is different from the first target number of ions; and
performing a second plurality of mass analysis scans to analyse the second ion species, wherein the second target number of ions is distributed amongst the second plurality of mass analysis scans.

15. The method of claim 14, wherein a number of mass analysis scans comprised within the second plurality of mass analysis scans performed to analyse the second ion species is different from a number of mass analysis scans comprised within the first plurality of mass analysis scans performed to analyse the first ion species.

16. The method of claim 1, wherein the ions are protein ions.

17. An analytical instrument for analysing ions, comprising:
a mass analyser; and
a controller;
wherein the controller is configured to:
determine a target number of ions to be analysed, the target number of ions based on a mass of the selected ion species, wherein the target number of ions to be analysed increases with increasing mass of the selected ion species; and
initiate the performance of a plurality of mass analysis scans by the mass analyser to analyse the selected ion species, wherein the target number of ions is distributed amongst the plurality of mass analysis scans.

18. The analytical instrument of claim 17, wherein the controller configured to determine a target number of ions to be analysed based on the mass of the selected ion species comprises the controller configured to:
determine a number of mass analysis scans required to analyse the target number of ions, wherein the target number of ions to be analysed is based on the mass of the selected ion species.

19. The analytical instrument of claim 17, wherein the mass analyser is a time-of-flight mass analyser.

20. The analytical instrument of claim 17, wherein the mass analyser is a first mass analyser, and the analytical instrument further comprises a second mass analyser for performing an MS1 scan for mass analysis of a sample to determine the mass of the selected ion species prior to the controller determining a target number of ions;
optionally, wherein the second mass analyser is an electrostatic orbital trapping analyser.
